(19) United States
(12) Patent Application Publication
(10) Pub. No.: US 2026/0289946 A1
(43) Pub. Date: Sep. 24, 2026

(54) SYSTEMS AND TECHNIQUES FOR INSTANCE SEGMENTATION

(71) Applicant: QUALCOMM Incorporated, San Diego, CA (US)

(72) Inventors: Yunling ZHENG, San Diego, CA (US); Xin LI, San Diego, CA (US); Jiancheng LYU, San Diego, CA (US); Yingyong QI, San Diego, CA (US)

(21) Appl. No.: 19/083,341

(22) Filed: Mar. 18, 2025

(51) Int. Cl. G06V 10/26; G06V 10/77; G06V 10/82

(52) U.S. Cl. CPC G06V 10/26; G06V 10/7715; G06V 10/82

(57) ABSTRACT

Systems and techniques are described herein for image processing. For example, a computing device can process an image feature map to sample subsets of pixels of a set of pixels associated with the image feature map; sort the subsets into a plurality of windows of the image feature map, wherein each subset from the subsets of pixels is sorted into a respective window from the plurality of windows, and wherein one or more pixels from each subset of pixels are adjusted from a first position to a second position within the image feature map based on the sorting; process the subsets of pixels sorted into the plurality of windows to determine a first plurality of features of the image feature map; and adjust the one or more pixels from each subset of pixels to position the one or more pixels from the second position to the first position.

### FIELD

The present disclosure generally relates to image processing. For example, aspects of the present disclosure relate to systems and techniques for instance segmentation in images and image feature maps.

### BACKGROUND

Computer vision tasks generally use resource intensive operations. For example, processing images or sequences of images to perform computer vision tasks such as object detection and instance segmentation generally require an amount of processing power limiting the hardware options which can be used to perform the task. In examples of devices or systems where computing resources can be limited (such as in mobile devices such as a smartphone, tablet, laptop, etc.), improvements to processes for performing computer vision tasks can expand the number of hardware options which can be used to perform the computer vision tasks. Further, adjusting computer vision tasks to take advantage of computer architectures to prioritize operations which the computer architectures can perform more efficiently can further expand the number of hardware options which can be used to perform the computer vision tasks.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for image processing is provided. The apparatus includes at least one memory and at least one processor coupled to the at least one memory and configured to: process, using a sparse sampling pattern, an image feature map to sample subsets of pixels of a set of pixels associated with the image feature map; sort the subsets of pixels into a plurality of windows of the image feature map, wherein each subset of pixels from the subsets of pixels is sorted into a respective window from the plurality of windows, and wherein one or more pixels from each subset of pixels are adjusted from a first position to a second position within the image feature map based on the sorting; process, using an attention layer of a machine learning model, the subsets of pixels sorted into the plurality of windows to determine a first plurality of features of the image feature map; and adjust the one or more pixels from each subset of pixels to position the one or more pixels from the second position to the first position within the image feature map.

In some aspects, a method for image processing is provided. The method includes: processing, using a sparse sampling pattern, an image feature map to sample subsets of pixels of a set of pixels associated with the image feature map; sorting the subsets of pixels into a plurality of windows of the image feature map, wherein each subset of pixels from the subsets of pixels is sorted into a respective window from the plurality of windows, and wherein one or more pixels from each subset of pixels are adjusted from a first position to a second position within the image feature map based on the sorting; processing, using an attention layer of a machine learning model, the subsets of pixels sorted into the plurality of windows to determine a first plurality of features of the image feature map; and adjusting the one or more pixels from each subset of pixels to position the one or more pixels from the second position to the first position within the image feature map.

In some aspects, a non-transitory computer-readable medium is provided having stored thereon instructions that, when executed by at least one processor, cause the at least one processor to: process, using a sparse sampling pattern, an image feature map to sample subsets of pixels of a set of pixels associated with the image feature map; sort the subsets of pixels into a plurality of windows of the image feature map, wherein each subset of pixels from the subsets of pixels is sorted into a respective window from the plurality of windows, and wherein one or more pixels from each subset of pixels are adjusted from a first position to a second position within the image feature map based on the sorting; process, using an attention layer of a machine learning model, the subsets of pixels sorted into the plurality of windows to determine a first plurality of features of the image feature map; and adjust the one or more pixels from each subset of pixels to position the one or more pixels from the second position to the first position within the image feature map.

In some aspects, an apparatus for image processing is provided. The apparatus includes: means for processing, using a sparse sampling pattern, an image feature map to sample subsets of pixels of a set of pixels associated with the image feature map; means for sorting the subsets of pixels into a plurality of windows of the image feature map, wherein each subset of pixels from the subsets of pixels is sorted into a respective window from the plurality of windows, and wherein one or more pixels from each subset of pixels are adjusted from a first position to a second position within the image feature map based on the sorting; means for processing, using an attention layer of a machine learning model, the subsets of pixels sorted into the plurality of windows to determine a first plurality of features of the image feature map; and means for adjusting the one or more pixels from each subset of pixels to position the one or more pixels from the second position to the first position within the image feature map.

In some aspects, one or more of the apparatuses described herein is, is part of, and/or includes a mobile device (e.g., a mobile telephone or other mobile device), an extended reality (XR) device or system (e.g., a virtual reality (VR) device, an augmented reality (AR) device, or a mixed reality (MR) device), a wearable device, a wireless communication device, a camera, a personal computer, a laptop computer, a vehicle or a computing device or component of a vehicle, a server computer or server device (e.g., an edge or cloud-based server, a personal computer acting as a server device, another device, or a combination thereof. In some aspects, the apparatus(es) can include a camera or multiple cameras for capturing one or more images. In some aspects, the apparatus(es) can include a display for displaying one or more images, notifications, and/or other displayable data. In some aspects, the apparatus(es) can include one or more sensors (e.g., one or more global positioning system (GPS) sensors, one or more global navigation satellite system (GNSS) sensors, one or more inertial measurement units (IMUs), such as one or more gyroscopes, one or more gyrometers, one or more accelerometers, any combination thereof, and/or other sensor).

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SoC), in accordance with aspects of the present disclosure.

FIG. 2 illustrates an example block diagram of a global window self-attention (GW-SA) layer of a machine learning model, in accordance with aspects of the present disclosure.

FIG. 3 illustrates an example block diagram of a global window self-attention block, in accordance with aspects of the present disclosure.

FIG. 4 illustrates an example block diagram representing an image processed using a global window self-attention block of a GW-SA layer of a machine learning model, in accordance with aspects of the present disclosure.

FIG. 5 illustrates an example block diagram of a machine learning system for image processing, in accordance with aspects of the present disclosure.

FIG. 6 is a flow diagram illustrating an example process of image processing, in accordance with aspects of the present disclosure.

FIG. 7 is a block diagram illustrating an example neural network, in accordance with aspects of the present disclosure.

FIG. 8 is a block diagram illustrating an example convolutional neural network, in accordance with aspects of the present disclosure.

FIG. 9 is a block diagram illustrating an example transformer, in accordance with aspects of the present disclosure.

FIG. 10 is a block diagram illustrating example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As mentioned, computer vision tasks generally use resource intensive operations. For example, processing images or sequences of images to perform computer vision tasks such as object detection and instance segmentation generally require an amount of processing power limiting the hardware options which can be used to perform the task. In examples of devices or systems where computing resources can be limited (such as in mobile devices such as a smartphone, tablet, laptop, etc.), improvements to processes for performing computer vision tasks can expand the number of hardware options which can be used to perform the computer vision tasks. Further, adjusting computer vision tasks to take advantage of computer architectures to prioritize operations which the computer architectures can perform more efficiently can further expand the number of hardware options which can be used to perform the computer vision tasks.

Machine learning models (e.g., neural networks, transformer architectures) can be used to perform a variety of computer vision tasks and image processing operations such as object detection and instance segmentation. In some examples, machine learning models can be used to identify objects represented in an image or sequence of images based on features (e.g., characteristics) of the objects. In further examples, machine learning models can be used to perform instance segmentation of objects represented in an image, sequences of images, and/or image feature maps associated with an image. An image feature map can be generated by processing an input image using a machine learning model, such as a neural network (e.g., a convolutional neural network (CNN), a transformer neural network, etc.) or other machine learning model, trained to extract features from the input image. In some cases, the machine learning model can include multiple layers or blocks, where each layer or block can output a feature map based on input provided to that layer or block (e.g., where a first layer of the machine learning model can process the input image and each subsequent layer or block can process a feature map output from a previous layer or block). In some cases, the machine learning model trained to extract features from an input (e.g., an input image) can be referred to as a backbone or feature extraction network.

Instance segmentation can refer to various computer vision tasks for defining boundaries of objects represented in an image or image feature maps. For example, instance segmentation can include differentiating between objects of the same object class (e.g., two apples in an image, three people in an image, etc.) based on various features of the objects represented in the image.

Images and image feature maps can be represented as a set of pixels (e.g., pixel values, feature pixels, feature pixel values, etc.). Some examples of image segmentation can be performed by processing an entire image or an image feature map associated with the image using self-attention layers to identify features associated with a set of pixels of the image or image feature map. Such an example of image segmentation can be resource intensive because processing the entire image or an image feature map associated with the image (e.g., the set of pixels) using self-attention layers can include determining features and relationships between each of the pixels from the set of pixels. Transformer models using self-attention layers across entire images, such as Mask2former and QSegTR, limits the usability of the transformer models on mobile devices and other systems in which computing resources can be limited, such as in autonomous or semi-autonomous vehicles.

To reduce the computing resources used in processing entire images using self-attention layers, some transformer based models (e.g., window-based attention models) can process portions of the image or an image feature map using the self-attention layers. The portions of the image or portions of the image feature map can be referred to as windows of the image. The windows of images can be areas (e.g., the portions) of the image or an image feature map corresponding to a subset of pixels from the set of pixels. Window-based attention models such as Swin transformers and CSwin transformers can perform image segmentation using window-based attention of images.

While such examples of transformer based models can reduce the computing resources used for image segmentation when compared to models processing an entire image using self-attention layers, window based attention models such as Swin and CSwin introduce other resource intensive or inefficient operations. For example, many window based attention models use varying window sizes and shapes which can be inefficient causing additional computations or inefficient computations (such as shifting masks in Swin) for computing devices. For example, window-based attention models such as Swin transformers and CSwin transformers use padding (e.g., adding 1s or 0s as additional pixel values of an image) to adjust windows of the image to a same size and shape. Further, window based attention models generally have reduced accuracy because of a lack of global features and relationships between the subsets of pixels from the set of pixels of the image or the image feature map.

Systems, apparatuses, electronic devices, methods (also referred to as processes), and computer-readable media (collectively referred to herein as “systems and techniques”) are described herein for image processing. In some aspects, the systems and techniques can include a machine learning model for image processing. For example, the machine learning model can be a neural network, convolutional neural network (CNN), transformer-based model, etc. The machine learning model can be trained on a set of training data including labeled images or image feature maps indicating classes of objects to be identified for instance segmentation.

In some aspects, the machine learning model can receive one or more images. For example, the machine learning model can receive an image or sequence of images (e.g., a video) in real time or near real time (e.g., a live broadcast or livestream of images). In some examples, the machine learning model can be part of a machine learning system including a backbone network (also referred to as a backbone), a pixel decoder including the machine learning model, and a decoder. In such an example, the backbone network can be a pretrained feature extraction network (e.g., including an encoder) to extract features of images. In some aspects, the backbone can be a feature pyramid network (FPN) that can determine or generate features of the images at multiple resolutions (also referred to as scales). For example, the backbone can process images to generate feature maps (e.g., image feature maps) of varying resolutions representing features of the image. In some cases, the high-level feature maps can include features representing parts of objects, detected objects, boundaries between objects, etc.

The backbone can provide the feature maps at varying resolutions to the pixel decoder. In some examples, the pixel decoder can receive the one or more image features as input. The pixel decoder can include one or more global window self-attention layers (also referred to as GW-SA layers) for determining features and relationships between pixels (and objects represented by the pixels) associated with image features. For example, the backbone can process images to determine image features (e.g., a feature map associated with the images). In some examples, the backbone can generate feature maps of varying resolutions. In such an example, the backbone can provide the feature maps of varying resolutions to the pixel decoder. The pixel decoder can process the image features (e.g., the feature maps) using GW-SA layers. For example, the GW-SA layers can include various blocks such as a global window self-attention block, a local window mixing block, and a feed forward network block.

In some aspects, the global window self-attention block can include various sub-layers of the GW-SA layer. For example, the global window self-attention block can include a global window selection layer, a window attention layer, and a global window reverse layer. The global window selection layer can be a sub-layer of the GW-SA represented in the global window self-attention block for determining windows of the image feature map in which to sort subsets pixels from a set of pixels representing or associated with an image. For example, the global window selection layer can be used to process an image feature map to sample subsets of pixels of a set of pixels associated with the image feature map. In such an example, the global window selection layer can use a sampling pattern (e.g., a sparse sampling pattern) to sample subsets of pixels from an image. In some examples, the sparse sampling pattern can include various sparse sampling techniques such as pixel-to-depth sampling, a depth-to-pixel sampling, and dilated convolutions. In some examples, the sparse sampling pattern can sample non-adjacent pixels into the subsets of pixels. In such an example, the subsets of pixels can include pixels not located adjacent to each other. For example, the systems and techniques can include sampling pixels of the image feature map into subsets of pixels not positioned adjacent to each other.

The global window selection layer can sort (e.g., shuffle) the subsets of pixels into a plurality of windows. For example, each subset of pixels can be sorted into a corresponding window of the image or image feature map. In such an example, the subsets of pixels (e.g., pixel values representing the pixels or embedding values representing the pixels) can be rearranged from original positions of the subsets of pixels based on the sorting. For example, one or more pixels from the subsets of pixels can be sorted into a respective window from the plurality of windows. In one example, the image feature map (or the image) can be divided into four windows. The systems and techniques can include dividing the image feature map into a plurality of windows equally shaped and equally sized. In such an example, the global window selection layer can sparsely sample image feature map into four subsets of pixels. Each of the four subsets can correspond to a window of the four windows. The global window selection layer can rearrange the image feature map to position each of the four subsets of pixels into the corresponding window of the image feature map.

The window attention layer of the global window self-attention block can be used to process the subsets of pixels sorted into the plurality of windows. For example, the subsets of pixels can be processed to determine features of the image (e.g., a first plurality of features of the image). For example, the features can indicate information associated with objects represented in the image. In another example, the features can indicate boundaries between objects, occlusions of the object, etc. The global window self-attention block can include a global window reverse layer. The global window reverse layer can be used to adjust the positions of the subsets of pixels of the image feature map to the original positions of subsets of pixels. For example, the positions of pixels from the subsets or pixels can be adjusted during sorting. The global window reverse layer can reverse the sorting by adjusting the pixels to the positions of the pixels prior to the sorting.

The local window mixing block can receive the image feature map and first plurality of features (e.g., a feature map representing the first plurality of features). The local window mixing block can include various convolutional layers. For example, the local window mixing block can include one or more convolutional layers for performing 2×2 convolutions of image feature maps to determine features of the images (or the input features). For example, the image feature map can be processed using one or more convolutional layers of the GW-SA layer (e.g., a machine learning model), the machine learning system, or the pixel decoder to determine a plurality of features of the image feature map (e.g., a second plurality of features) and a reduced resolution representation of the image feature map.

For example, the convolutional layers of the local window mixing block can include a 2×2 kernel to perform 2×2 convolutions. The convolutional layers can be used to downsample the image feature map and determine a plurality of features of the image. In some examples, the downsampled image feature map (e.g., a reduced resolution representation of the image) can be padded to maintain the size and shape of the downsampled image feature map. For example, the padding can be added to maintain the downsampled image feature map as having the same size and shape as the image feature map processed by the global window self-attention block. In some examples, the padding can include adding zeroes as pixel values of the image feature map to set the size and the shape of the downsampled image feature map to the image feature map processed by the global window self-attention block.

In some aspects, the first plurality of features and the second plurality of features can be added to the image feature map processed at the global window self-attention block using a bypass connection of the GW-SA layer. The combination can be provided to a feedforward network to introduce non-linearity of to the first plurality of features and the second plurality of features and provide the first plurality of features, the second plurality of features, and the image feature map to a subsequent GW-SA layer of the pixel decoder.

In some examples, the pixel decoder can include multiple GW-SA layers. For example, the pixel decoder can include three GW-SA layers. The GW-SA layers can be used to determine features and relationships between subsets of pixels of images feature such as objects represented in the image and boundaries of the objects within the image. The features and relationships (e.g., the first plurality of features and the second plurality of features of the image) can be up-sampled and combined using a feature combination and enhancement engine of the pixel decoder. For example, the feature combination and enhancement engine can combine the plurality of features of the image determined using the backbone and the plurality of features determined using the GW-SA layers to generate a combined feature map representation of the features.

The pixel decoder can provide the combined feature map (e.g., a combined image feature map) including the first plurality of features and the second plurality of features to a transformer decoder. The transformer decoder can use the combined feature map from the feature combination and enhancement engine to perform computer vision tasks such as object detection and instance segmentation of objects represented in the image. For example, the transformer decoder can use the combined feature map to indicate borders or boundaries of an object to determine where objects are located within the image. In some examples, the transformer decoder can highlight objects within the image to indicate boundaries between objects in the images.

For example, the output of the transformer decoder can be an image feature map with individual objects of the image feature map having a filter applied to the object to adjust the color of the object represented in the image feature map to indicate predicted boundaries of the object in the image. In some examples, instance segmentation can be performed for a class of objects represented in the image feature map. In such an example, the backbone and pixel decoder can determine features associated with the class of objects. The transformer decoder can apply the filter to image features (or the image feature map) at the pixel positions of an object within the class of objects (e.g., when the class of objects is an apple, the transformer decoder can apply filters to objects determined to be apples and not other objects represented in the image).

Various aspects of the present disclosure will be described with respect to the figures.

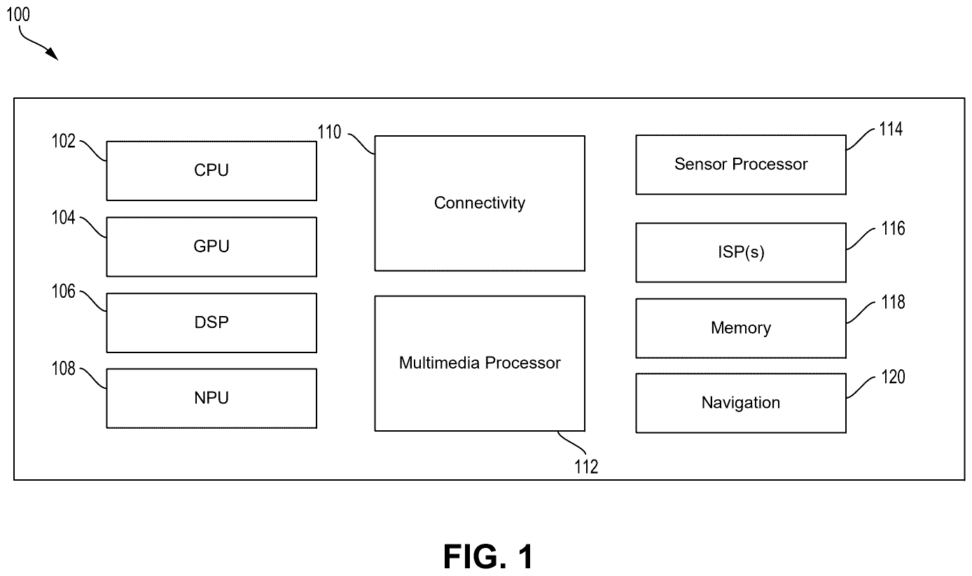

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize audio signals. In one implementation, the NPU is implemented in the CPU 102, DSP 106, and/or GPU 104. The SOC 100 may also include one or more sensors 114 such as but not limited to one or more microphones, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform audio processing, such as denoising audio signals of wind noise, using machine learning techniques according to aspects of the present disclosure discussed herein. For example, SOC 100 and/or components thereof may be configured to perform processing techniques such as but not limited to: segment shifting, shuffle correlation, gain shifting, segment masking, and additional processing techniques. SOC 100 can be part of a computing device or multiple computing devices. In some examples, SOC 100 can be part of an electronic device (or devices) such as an audio recording device, camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Various recurrent architectures (e.g., RNNs) that include one or more recurrent cells among the feed-forward layers of the network can be used to perform image processing operations to generate processed image having a relatively high quality. For example, recurrent cells can be implemented using a vanilla-RNN architecture, a Conv-GRU (Gated Recurrent Unit) architecture, a Conv-LSTM (Long Short-Term Memory) architectures, among various others.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of audio can benefit from first learning to recognize individual spoken words, instruments in music, etc. These features may be combined at higher layers in different ways to recognize sounds such as speech, instruments, wind noise, etc.

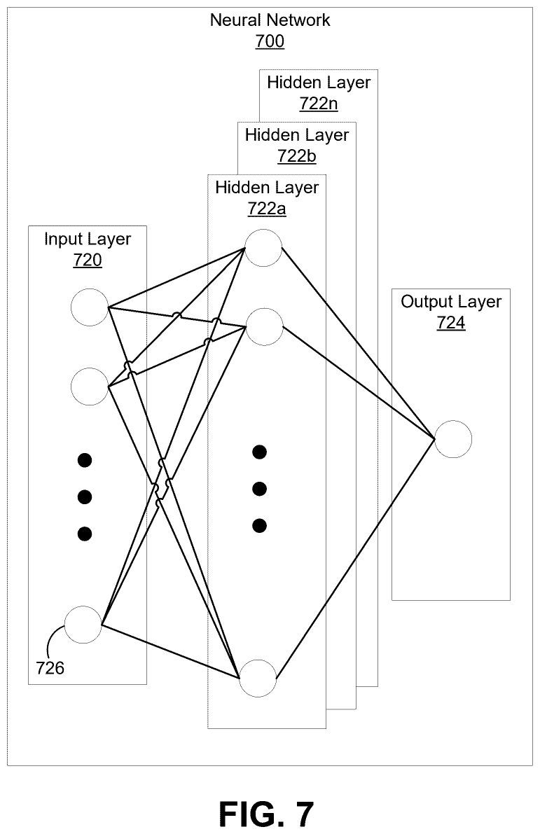

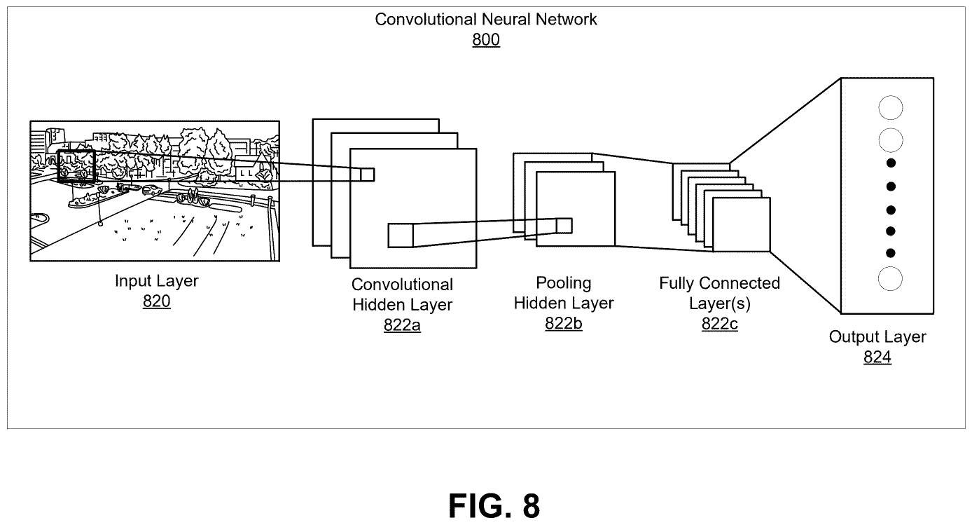

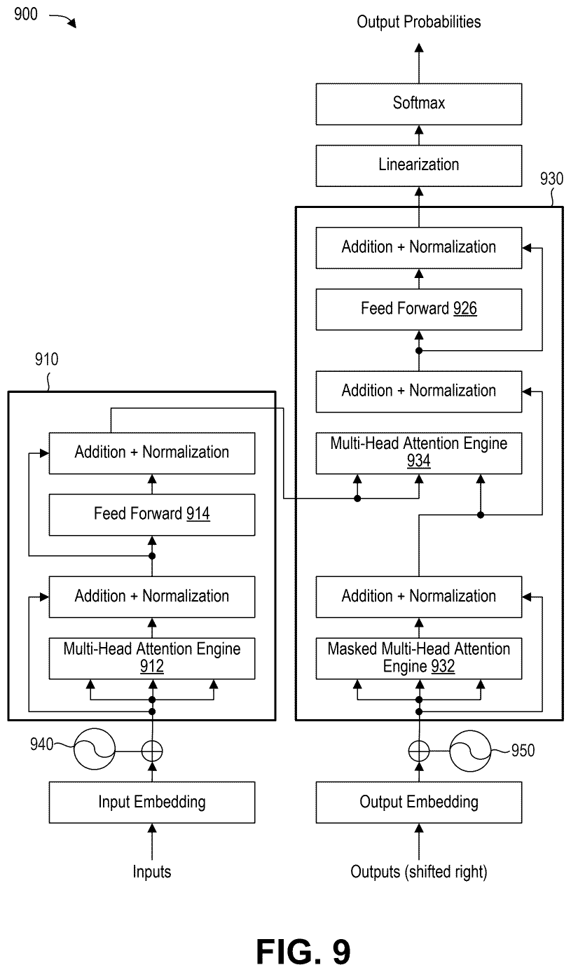

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. Further description of machine learning model architectures is provided in the description of FIG. 7, FIG. 8, and FIG. 9.

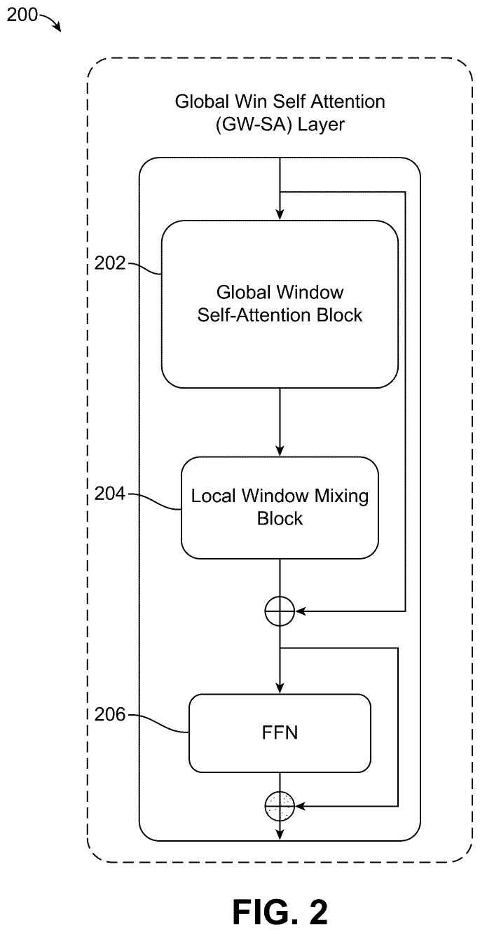

The SOC 100 of FIG. 1 can be used to perform the various systems and techniques described in the descriptions of FIG. 2-FIG. 10. For example, the SOC 100 can be used to perform operations of the machine learning system 500 of FIG. 2 including instance segmentation and object detection.

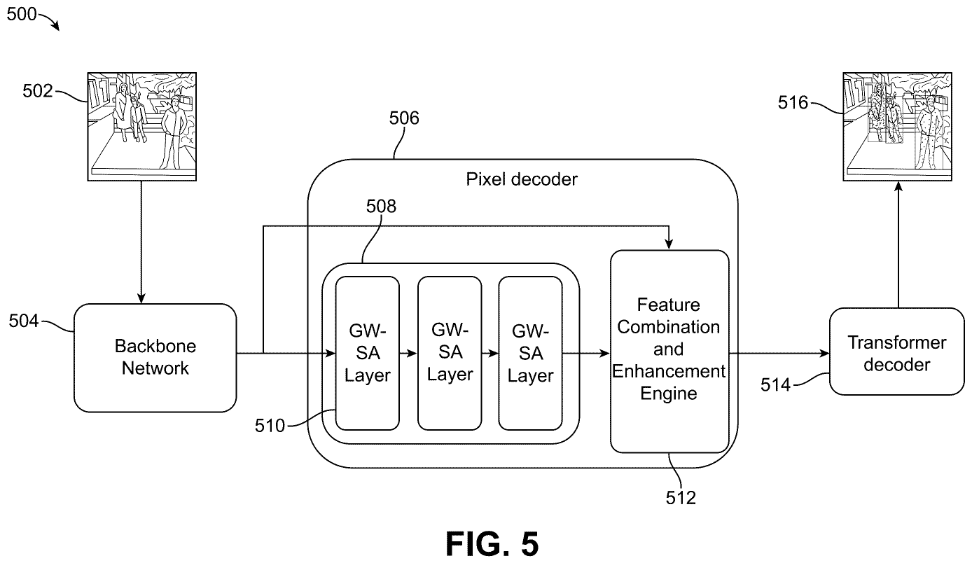

FIG. 2 is a block diagram illustrating an example global window self-attention (GW-SA) layer 200 of a machine learning model (e.g., the pixel decoder 506 of machine learning system 500 described in the description of FIG. 5). The GW-SA layer 200 can be used to process subsets of pixels of images (or features extracted from images) to determine features and relationships of the subsets of pixels. For example, the GW-SA layer 200 can include a global window self-attention block 202, a local window mixing block 204, and a feedforward network 206 (FFN). In some examples, multiple GW-SA layers can be interconnected to provide features determined from processing images (or features extracted from images) between the GW-SA layers.

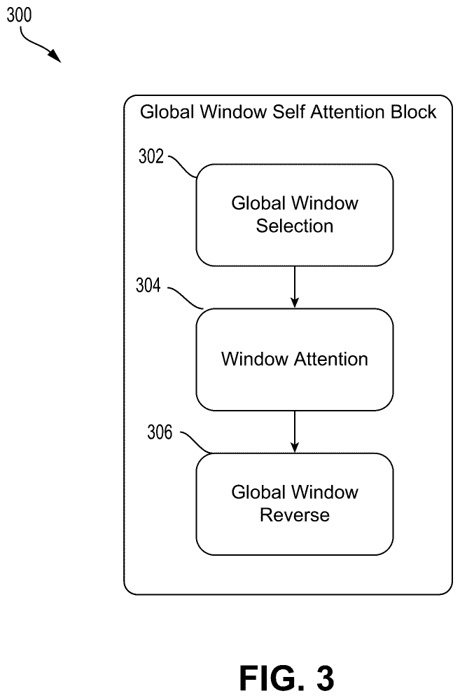

The GW-SA layer 200 can be used to process an image feature map or images to determine features of the image feature map (or image) which can be used for computer vision tasks such as object detection and instance segmentation. For example, the GW-SA layer 200 can use the global window self-attention block 202 to perform self-attention of windows of an image feature map (e.g., to perform window attention). The global window self-attention block 202 can include multiple sub-layers, described further in the description of FIG. 3, to perform self-attention of windows of the image or image feature map.

The global window self-attention block 202 can receive an image feature map (or one or more image) received at the GW-SA layer 200 and can process the image feature map into windows. For example, the global window self-attention block can be used to set windows (e.g., portions or regions) of an image or image feature map. In such an example, the global window self-attention block can be used to determine different windows of an image feature map (e.g., to divide the image into separate portions). The windows can be equally shaped and equally sized. In such an example, the length and width of each of the windows can be equal (e.g., when a first window is determined to be 200 pixels by 200 pixels, subsequent windows of the image feature map can be determined to be 200 pixels by 200 pixels).

The global window self-attention block 202 can sample subsets of pixels from a set of pixels representing an image feature map (e.g., the image or image feature map with set windows) and sort the subsets of pixels into the windows. For example, the positions of the subsets of pixels can be moved (e.g., shuffled) to windows based on sampling pattern of the pixels. In some examples, the global window self-attention block 202 can perform sparse sampling of the subsets of pixels. In such an example, the global window self-attention block 202 can sample non-adjacent subsets of pixels to arrange in the windows of the image feature map. The global window self-attention block 202 can perform various sparse sampling techniques such as pixel-to-depth sampling, a depth-to-pixel sampling, and dilated convolutions.

The GW-SA layer 200 can use the global window self-attention block 202 to perform self-attention at the windows (e.g., window attention) of the subsets of pixels sorted into the windows of the blocks to determine a first set of features associated with the subsets of pixels of the set of pixels representing the image feature map. For example, the first set of features can include features and relationships representing the detection of objects in the image (e.g., represented in the image feature map associated with the image), boundaries of objects in the image, occlusions of the objects, etc. In some examples, the first set of features can be represented as an additional feature map of the image.

The global window self-attention block 202 can rearrange the pixels to reverse the sorting of the subsets of pixels into windows. For example, the global window self-attention block 202 can return the subsets of pixels to the original positions of the subsets of pixels from the image feature map received by the global window self-attention block 202. Further description of the global window self-attention block 202 and the sub-layers the global window self-attention block 202 is provided in the description of FIG. 3.

The plurality of features determined using the global window self-attention block 202 and the image feature map (e.g., the rearranged image feature map reversing the sorting of the subsets of pixels) can be provided to the local window mixing block 204. The local window mixing block can include one or more convolutional layers to determine features (e.g., a second plurality of features) of the image. In one example, the convolutional layers can include a 2×2 kernel to perform 2×2 convolutions of the image feature map. Additional kernel sizes can be used to perform convolutions such as 3×3 kernels, 5×5 kernels, etc.

The local window mixing block 204 can output a reduced resolution representation of the image feature map (e.g., a downsampled representation of the image feature map). The local window mixing block 204 can add padding to the reduced resolution representation of the image feature map to set the dimensions of the image feature map to the dimensions of the image feature map received by the global window self-attention block 202. For example, padding can include adding additional pixel values to the reduced resolution representation of the image feature map such as by adding 0s and 1s to adjust the shape and size of the reduced resolution representation to the shape and size of the image feature map received by the global window self-attention block 202.

The features determined using the global window self-attention block 202 and the local window mixing block 204 (e.g., the first plurality of features and the second plurality of features) can be combined with features determined from previous GW-SA layers. For example, GW-SA layer 200 can include a bypass connection to combine the image and features associated with the image feature maps from previous GW-SA layers or other layers of a machine learning model with the first plurality of features and the second plurality of features.

The combination can be provided to the feedforward network 206. For example, the feedforward network 206 can be used to process the combination to introduce non-linearity to the combination (e.g., to the first plurality of features and the second plurality of features). The GW-SA layer 200 can include a bypass connection. The GW-SA layer 200 can use the bypass connection to combine the output of the feedforward network 206 with the combination of features determined using the global window self-attention block 202 and the local window mixing block 204, the result of which can be provided to subsequent GW-SA layers or other layers of a machine learning model.

FIG. 3 is a block diagram illustrating an example global window self-attention block 300. The global window self-attention block 300 can include multiple layers (e.g., sub-layers of the GW-SA layer 200 of FIG. 2). For example, the global window self-attention block 300 can include a global window selection layer 302, a window attention layer 304, and a global window reverse layer 306.

The global window self-attention block 300 can be used to process an image feature map (or image) to determine features of the image feature map used for computer vision tasks such as object detection and instance segmentation. For example, the global window self-attention block 300 can use the global window selection layer 302 to sort (e.g., shuffle) subsets of pixels of the image feature map (or image) into a plurality of windows. Windows can be represented as regions or areas of the image feature map. In some examples, the windows can be each equally shaped and equally sized (e.g., having the same pixel dimensions). For example, the global window selection layer 302 can sort subsets of pixels of the image feature map (or the image) into equally shaped and equally sized windows of the image feature map.

The global window selection layer 302 can sort the subsets of pixels by sampling the image feature map for pixels and arranging the subsets of pixels based on a sampling pattern. For example, the global window selection layer 302 can use sparse sampling to sample the subsets of pixels. The sampling pattern can refer to methods of selecting pixels of the image feature map to be within a subset of pixels. In some examples, the sampling pattern can be random. In other examples, the sampling pattern can use uniform spacing (e.g., sampling every other pixel, every third pixel, etc.).

The global window selection layer can sort the subsets of pixels into a corresponding window of the image feature map. For example, the subsets of pixels (e.g., pixel values representing the pixels or embedding values representing the pixels) can be rearranged from a first position (outside or inside the window) to a second position inside the window (e.g., within the boundaries of the window of the image feature map). In some example, one or more pixels of the image feature map may be unchanged in position based on the sampling pattern and whether the pixel was already located within the window of the image feature map.

The window attention layer 304 can process the subsets of pixels sorted into corresponding windows. For example, the window attention layer 304 can perform self-attention operations using the subsets of pixels within a window to determine features of the image feature map (e.g., a first plurality of features of the image feature map). The features can indicate information and relationships between pixels within the subset of pixels. The features can further indicate information associated with the objects represented in the pixels of the image feature map, such as boundaries between objects.

The global window reverse layer 306 can adjust the positions of the subsets of pixels to reverse the sorting from the global window selection layer 302. For example, the global window selection layer 302 can sort subsets of pixels into different windows adjusting the order of subsets of pixels of the image feature map. The global window reverse layer 306 can sort the subsets of pixels to the original positions of the subsets of pixels of the image feature map processed using the global window self-attention block 300.

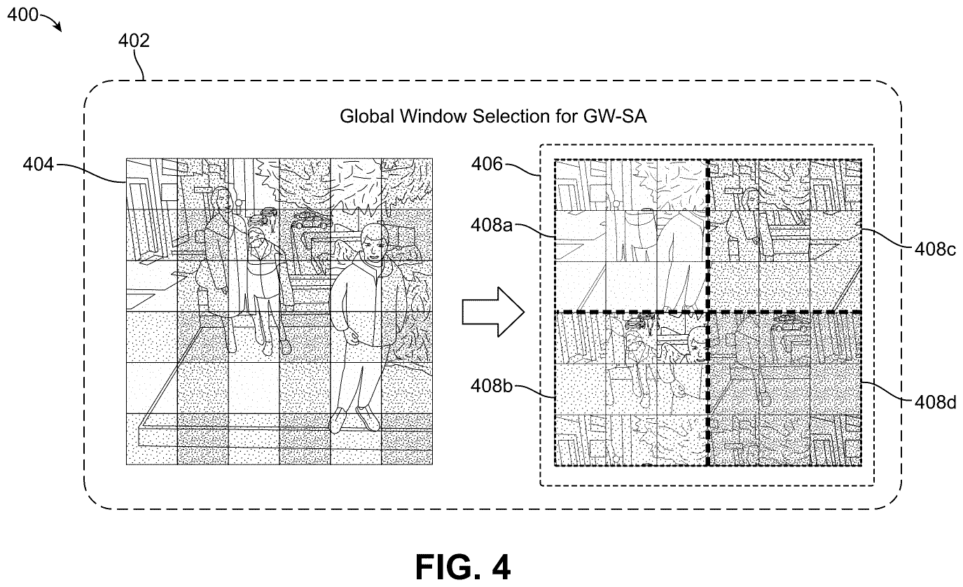

FIG. 4 is a block diagram 400 illustrating an example of an image feature map processed using a global window self-attention block 402 (e.g., the global window self-attention block 202 of FIG. 2 or the global window self-attention block 300 of FIG. 3). The block diagram 400 includes a first image (or a first feature map) 404 represented as a set of pixels. The global window self-attention block 402 can sample the subsets of pixels of the first image (or the first feature map) 404 and sort the subsets of pixels into various groups. For example, the global window self-attention block 402 can use sparse sampling techniques to sample pixels from the first image 404 in a uniform order (e.g., sampling every other pixel line by line of the image, sampling every third pixel, etc.). In some examples, the sampling can be random.

The global window self-attention block 402 can rearrange the subsets of pixels into windows 408a, 408b, 408c, and 408d to generate the second image (or the second feature map) 406. The second image (or the second feature map) 406 can include the subsets of pixels from the first image (or the first feature map) rearranged into windows 408a, 408b, 408c, and 408d shuffling the first image (or the first feature map). For example, a pixel (or feature associated with the pixel) which was in a first position of an image can be moved to a second position within a window corresponding to the pixel in a second position.

FIG. 5 is a block diagram illustrating an example machine learning system 500 for image processing. For example, the machine learning system 500 can perform computer vision tasks such as object detection and instance segmentation. The machine learning system 500 can include a backbone network 504, a pixel decoder 506, and a transformer decoder 514.

The machine learning system 500 can receive an image 502 or sequence of images. The backbone network 504 can process the image to determine features associated with the image. For example, the backbone network 504 can be a feature pyramid network (FPN) to determine features of the images at multiple resolutions. For example, the backbone network 504 can process the image 502 to generate feature maps of varying resolutions representing features of objects represented in the image.

The backbone network 504 can provide the feature maps at varying resolutions to the pixel decoder 506. The pixel decoder 506 can include one or more global window self-attention layers 510, also referred to as GW-SA layers, for determining relationships between features of the image (e.g., features and relationships of objects represented in pixels of the image). For example, the GW-SA layers 510 can include GW-SA layer 200 of FIG. 2. The GW-SA layers 510 can include various blocks including sub-layers the GW-SA layers 510, such as the global window self-attention block 202 of FIG. 2 and the global window self-attention block 300 of FIG. 3, the local window mixing block 204 of FIG. 2, and the feedforward network 206 of FIG. 2.

The GW-SA layers 510 can process the feature maps of the backbone network 504 to determine relationships between features of the image (e.g., features associated with the objects represented in the image). The features determined using the GW-SA layers 510 can be up-sampled and combined with the feature maps of the backbone network 504 using a feature combination and enhancement engine 512. The combined features from the backbone network 504 and the GW-SA layers 510 can be provided to the transformer decoder 514.

The transformer decoder 514 can use the combined features from the feature combination and enhancement engine 512 to perform computer vision tasks such as object detection and instance segmentation of objects represented in the image 502. In some examples, the transformer decoder 514 can highlight objects within the image 502 based on the combined features, such as to provide an outline of boundaries between objects in the image. In some examples, the transformer decoder 514 can generate a representation (or an output) 516 including the highlights or other indicators of different objects represented in the image 516.

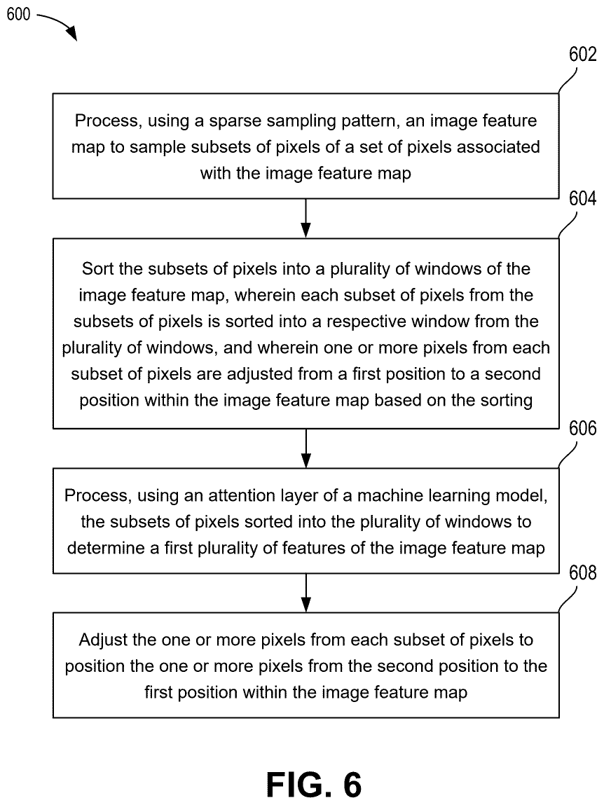

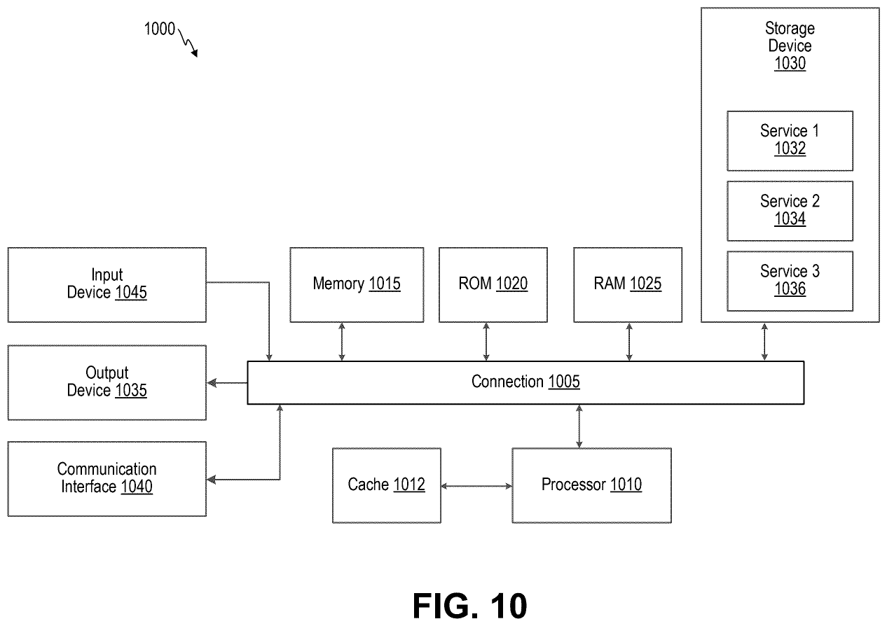

FIG. 6 is a flow chart illustrating an example of a process 600 for image processing, such as to perform object detection and instance segmentation. The process 600 can be performed by a computing device (e.g., SOC 100 of FIG. 1, computing device or computing system 1000 of FIG. 10, etc.) or by a component or system (e.g., the machine learning system 500 of FIG. 5, GW-SA layer 200 of FIG. 2, the GW-SA layers 510 of FIG. 5, etc.), a chipset, one or more processors central processing units (CPUs), digital signal processors (DSPs), graphics processing units (GPUs), any other type of processor(s), any combination thereof, or other component or system) of the computing device. The operations of the process 600 can be implemented as software components that are executed and run on one or more processors (e.g., processor 1010 of FIG. 10 or other processor(s)) of the computing device. Further, the transmission and reception of signals by the computing device in the process 600 can be enabled, for example, by one or more antennas, one or more microphones, and/or one or more transceivers (e.g., wireless transceiver(s)).

At block 602, the computing device (or component thereof) can process an image feature map (or an image) to sample subsets of pixels of a set of pixels associated with the image feature map. For example, the computing device (or component thereof) can use a decoder, such as the pixel decoder 506 of FIG. 5, to process the image feature map. In some examples, the computing device (or component thereof) can use a sparse sampling pattern to sample the subsets of pixels. For example, the sparse sampling pattern can sample non-adjacent pixels into the subsets of pixels, such as by skipping every other pixel of the image feature map (or image) during sampling. In another example, the computing device (or component thereof) can use various sparse sampling patterns such as pixel-to-depth sampling, depth-to-pixel sampling, or dilated convolutions to sample the pixels.

At block 604, the computing device (or component thereof) can sort the subsets of pixels into a plurality of windows of the image feature map. In such an example, each subset of pixels from the subsets of pixels can be sorted into a respective window from the plurality of windows. For example, the image feature map (or image) can be divided into different regions (e.g., areas of the image feature map), such as four regions. In such an example, the computing device (or component thereof) can sample the pixels of the image feature map into different subsets of pixels with each subset of pixels corresponding to a region. The computing device (or component thereof) can sort the subsets of pixels into the corresponding region. For example, the computing device can adjust one or more pixels from each subset of pixels from a first position to a second position within the image feature map based on the sorting of the subsets of pixels (e.g., arranging pixels associated with a subset of pixels to be positioned within the region corresponding to the subset). In some examples, the plurality of windows can be equally shaped and equally sized (e.g., of equal dimensions).

At block 606, the computing device (or component thereof) can process the subsets of pixels sorted into the plurality of windows to determine a first plurality of features of the image feature map. For example, the computing device (or component thereof) can use an attention layer of a machine learning model to process the subsets of pixels. In some examples, the attention layer can be a layer of a decoder, such as the pixel decoder 506 of FIG. 5. In further examples, the computing device (or component thereof) can use the attention layer to process each subset of pixels individually. In such an example, features determined using the attention layer can correspond to the plurality of windows associated with the subsets of pixels.

At block 608, the computing device (or component thereof) can adjust the one or more pixels from each subset of pixels to position the one or more pixels from the second position to the first position within the image feature map. For example, the computing device (or component thereof) can adjust the position of the pixels from the subset of pixels to sort the pixels into the position in the image feature map (or image) the pixels were initially positioned (e.g., position of the pixels before the sorting at block 604). In further examples, the computing device (or component thereof) can process, the image feature map to determine a second plurality of features of the image feature map and a reduced resolution representation of the image feature map. For example, the reduced resolution representation of the image feature map can be the same size and shape as the image feature map with padding added. For example, the reduced resolution representation can include bit padding (e.g., added 1s and 0s) such that the image feature map is the same size and shape as the image feature map.

In further examples, the computing device (or component thereof) can use a convolutional layer of the machine learning model. For example, the machine learning model can be the pixel decoder 506 of FIG. 5. In further examples, the computing device (or component thereof) can determine on or more objects represented in an image associated with the image feature map based on the first plurality of features and the second plurality of features. For example, the computing device (or component thereof) can process the first plurality of features and the second plurality of features to perform object detection of objects represented in the image.

As noted above, various aspects of the present disclosure can use machine learning models or systems. FIG. 7 is an illustrative example of a deep learning neural network 700 that can be used to implement the machine learning based feature extraction and/or activity recognition (or classification) described above. An input layer 720 includes input data. In one illustrative example, the input layer 720 can include data representing the pixels of an input video frame. The neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. The neural network 700 further includes an output layer 724 that provides an output resulting from the processing performed by the hidden layers 722a, 722b, through 722n.

The neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 724, at which an output is provided. In some cases, while nodes (e.g., node 726) in the neural network 700 are shown as having multiple output lines, a node has a single output and all lines shown as being output from a node represent the same output value.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 724, at which an output is provided. In some cases, while nodes (e.g., node 726) in the neural network 700 are shown as having multiple output lines, a node has a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 724. In an example in which the neural network 700 is used to reduce wind noise in an audio signal, the neural network 700 can be trained using training data generated in the process described in FIG. 6.

In some cases, the neural network 700 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until the neural network 700 is trained well enough so that the weights of the layers are accurately tuned.

For the example of reducing noise in audio signals, the forward pass can include passing training data through the neural network 700. The weights are initially randomized before the neural network 700 is trained. As an illustrative example, an audio signal can include an array of numbers representing a sequence of sounds. Each number in the array can include a numerical value representing sounds in sequence. In one example, the array is a one-dimensional sequence of numbers.

As noted above, for a first training iteration for the neural network 700, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 700 is unable to determine low level features and thus cannot make an accurate determination of what the classification of the object might be. A loss function can be used to analyze error in the output. Any suitable loss function definition can be used, such as the loss function described in the description of FIG. 5. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training data since the actual values will be much different than the predicted output. The goal of training is to minimize the amount of loss so that the predicted output is the same as the training label. The neural network 700 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 700 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 700 can include any other deep network other than a CNN, such as an autoencoder, a deep belief nets (DBNs), a Recurrent Neural Networks (RNNs), among others.

FIG. 8 is an illustrative example of a convolutional neural network (CNN) 800. FIG. 8 provides an example for operation of a convolutional neural network (CNN) 800 on images and video, however the structure of the convolutional neural network (CNN) may be further adapted to receive one-dimensional inputs such as audio signals. The input layer 820 of the CNN 800 includes data representing an image or frame. For example, the data can include an array of numbers representing the pixels of the image, with each number in the array including a value from 0 to 255 describing the pixel intensity at that position in the array. For example, the array can include a 28×28×3 array of numbers with 28 rows and 28 columns of pixels and 3 color components (e.g., red, green, and blue, or luma and two chroma components, or the like). The image can be passed through a convolutional hidden layer 822a, an optional non-linear activation layer, a pooling hidden layer 822b, and fully connected hidden layers 822c to get an output at the output layer 824. While only one of each hidden layer is shown in FIG. 8, one of ordinary skill will appreciate that multiple convolutional hidden layers, non-linear layers, pooling hidden layers, and/or fully connected layers can be included in the CNN 800. The output can indicate a single class of an object or can include a probability of classes that best describe the object in the image.

The first layer of the CNN 800 is the convolutional hidden layer 822a. The convolutional hidden layer 822a analyzes the image data of the input layer 820. Each node of the convolutional hidden layer 822a is connected to a region of nodes (pixels) of the input image called a receptive field. The convolutional hidden layer 822a can be considered as one or more filters (each filter corresponding to a different activation or feature map), with each convolutional iteration of a filter being a node or neuron of the convolutional hidden layer 822a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 822a. Each connection between a node and a receptive field for that node learns a weight and, in some cases, an overall bias such that each node learns to analyze its particular local receptive field in the input image. Each node of the hidden layer 822a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 822a is due to each node of the convolutional layer being applied to its corresponding receptive field. For example, a filter of the convolutional hidden layer 822a can begin in the top-left corner of the input image array and can convolve around the input image. As noted above, each convolutional iteration of the filter can be considered a node or neuron of the convolutional hidden layer 822a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 822a. For example, a filter can be moved by a step amount (referred to as a stride) to the next receptive field. The stride can be set to 1 or another suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 822a.

The mapping from the input layer to the convolutional hidden layer 822a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 822a can include several activation maps in order to identify multiple features in an image. The example shown in FIG. 8 includes three activation maps. Using three activation maps, the convolutional hidden layer 822a can detect three different kinds of features, with each feature being detectable across the entire image.

In some examples, a non-linear hidden layer can be applied after the convolutional hidden layer 822a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 800 without affecting the receptive fields of the convolutional hidden layer 822a.

The pooling hidden layer 822b can be applied after the convolutional hidden layer 822a (and after the non-linear hidden layer when used). The pooling hidden layer 822b is used to simplify the information in the output from the convolutional hidden layer 822a. For example, the pooling hidden layer 822b can take each activation map output from the convolutional hidden layer 822a and generates a condensed activation map (or feature map) using a pooling function. Max-pooling is one example of a function performed by a pooling hidden layer. Other forms of pooling functions be used by the pooling hidden layer 822a, such as average pooling, L2-norm pooling, or other suitable pooling functions. A pooling function (e.g., a max-pooling filter, an L2-norm filter, or other suitable pooling filter) is applied to each activation map included in the convolutional hidden layer 822a. In the example shown in FIG. 8, three pooling filters are used for the three activation maps in the convolutional hidden layer 822a.

In some examples, max-pooling can be used by applying a max-pooling filter (e.g., having a size of 2×2) with a stride (e.g., equal to a dimension of the filter, such as a stride of 2) to an activation map output from the convolutional hidden layer 822a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 822a having a dimension of 24×24 nodes, the output from the pooling hidden layer 822b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 800.

The final layer of connections in the network is a fully-connected layer that connects every node from the pooling hidden layer 822b to every one of the output nodes in the output layer 824. Using the example above, the input layer includes 28×28 nodes encoding the pixel intensities of the input image, the convolutional hidden layer 822a includes 3×24×24 hidden feature nodes based on application of a 5×5 local receptive field (for the filters) to three activation maps, and the pooling hidden layer 822b includes a layer of 3×12×12 hidden feature nodes based on application of max-pooling filter to 2×2 regions across each of the three feature maps. Extending this example, the output layer 824 can include ten output nodes. In such an example, every node of the 3×12×12 pooling hidden layer 822b is connected to every node of the output layer 824.

The fully connected layer 822c can obtain the output of the previous pooling hidden layer 822b (which should represent the activation maps of high-level features) and determines the features that most correlate to a particular class. For example, the fully connected layer 822c layer can determine the high-level features that most strongly correlate to a particular class and can include weights (nodes) for the high-level features. A product can be computed between the weights of the fully connected layer 822c and the pooling hidden layer 822b to obtain probabilities for the different classes. For example, if the CNN 800 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 824 can include an M-dimensional vector (in the prior example, M=10). M indicates the number of classes that the CNN 800 can choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 9 is a block diagram of an example transformer in accordance with some aspects of the disclosure.

In a convolutional neural network (CNN) model, the number of operations required to relate signals from two arbitrary input or output positions grows in the distance between positions, which makes learning dependencies at different distant positions challenging for a CNN model. A transformer 900 reduces the operations of learning dependencies by using an encoder 910 and a decoder 930 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 910 is composed of a stack of six identical layers and each layer has two sub-layers. The first sub-layer is a multi-head self-attention engine 912, and the second sub-layer is a fully connected feed-forward network 914. A residual connection (not shown) connects around each of the sub-layers followed by normalization.

In this example transformer 900, the decoder 930 is also composed of a stack of six 6 identical layers. The decoder also includes a masked multi-head self-attention engine 932, a multi-head attention engine 934 over the output of the encoder 910, and a fully connected feed-forward network 926. Each layer includes a residual connection (not shown) around the layer, which is followed by layer normalization. The masked multi-head self-attention engine 932 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 940 to encode positions because the model does not contain recurrence and convolution and relative or absolute position of the tokens is needed. In the transformer 900, the positional encodings are added to the input embeddings at the bottom layer of the encoder 910 and the decoder 930. The positional encodings are summed with the embeddings because the positional encodings and embeddings have the same dimensions. A corresponding position decoder 950 is configured to decode the positions of the embeddings for the decoder 930.

In some aspects, the transformer 900 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 900 can process input sequences of variable length, making it well-suited for natural language processing tasks where input lengths can vary greatly. Additionally, the self-attention mechanism allows the transformer 900 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 10 is a diagram illustrating an example of a system for implementing certain aspects of the present technology. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, an engine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for image processing, the apparatus comprising: at least one memory; and at least one processor coupled to the at least one memory and configured to: process, using a sparse sampling pattern, an image feature map to sample subsets of pixels of a set of pixels associated with the image feature map; sort the subsets of pixels into a plurality of windows of the image feature map, wherein each subset of pixels from the subsets of pixels is sorted into a respective window from the plurality of windows, and wherein one or more pixels from each subset of pixels are adjusted from a first position to a second position within the image feature map based on the sorting; process, using an attention layer of a machine learning model, the subsets of pixels sorted into the plurality of windows to determine a first plurality of features of the image feature map; and adjust the one or more pixels from each subset of pixels to position the one or more pixels from the second position to the first position within the image feature map.

Aspect 2. The apparatus of Aspect 1, wherein the plurality of windows are equally shaped and equally sized.

Aspect 3. The apparatus any of Aspects 1 to 2, wherein the sparse sampling pattern samples non-adjacent pixels into the subsets of pixels.

Aspect 4. The apparatus any of Aspects 1 to 3, wherein the sparse sampling pattern includes at least one of a pixel-to-depth sampling, a depth-to-pixel sampling, or dilated convolutions.

Aspect 5. The apparatus any of Aspects 1 to 4, wherein the at least one processor is configured to: process, using a convolutional layer of the machine learning model, the image feature map to determine a second plurality of features of the image feature map and a reduced resolution representation of the image feature map.

Aspect 6. The apparatus any of Aspects 1 to 5, wherein the reduced resolution representation of the image feature map includes padding and is of a same size and shape as the image feature map.

Aspect 7. The apparatus any of Aspects 1 to 6, wherein the at least one processor is configured to: determine one or more objects represented in an image associated with the image feature map based on the first plurality of features and the second plurality of features.

Aspect 8. The apparatus any of Aspects 1 to 7, wherein the attention layer is a window attention layer used to process each subset of pixels individually and wherein features determined using the attention layer correspond to the plurality of windows associated with the subsets of pixels.

Aspect 9. A method comprising: processing, using a sparse sampling pattern, an image feature map to sample subsets of pixels of a set of pixels associated with the image feature map; sorting the subsets of pixels into a plurality of windows of the image feature map, wherein each subset of pixels from the subsets of pixels is sorted into a respective window from the plurality of windows, and wherein one or more pixels from each subset of pixels are adjusted from a first position to a second position within the image feature map based on the sorting; processing, using an attention layer of a machine learning model, the subsets of pixels sorted into the plurality of windows to determine a first plurality of features of the image feature map; and adjusting the one or more pixels from each subset of pixels to position the one or more pixels from the second position to the first position within the image feature map.

Aspect 10. The method of Aspect 9, wherein the plurality of windows are equally shaped and equally sized.

Aspect 11. The method any of Aspects 9 to 10, wherein the sparse sampling pattern samples non-adjacent pixels into the subsets of pixels.

Aspect 12. The method any of Aspects 9 to 11, wherein the sparse sampling pattern includes at least one of a pixel-to-depth sampling, a depth-to-pixel sampling, or dilated convolutions.

Aspect 13. The method any of Aspects 9 to 12, further comprising: processing, using a convolutional layer of the machine learning model, the image to determine a second plurality of features of the image feature map and a reduced resolution representation of the image feature map.

Aspect 14. The method any of Aspects 9 to 13, wherein the reduced resolution representation of the image feature map includes padding and is of a same size and shape as the image feature map.

Aspect 15. The method any of Aspects 9 to 14, further comprising: determining one or more objects represented in an image associated with the image feature map based on the first plurality of features and the second plurality of features.

Aspect 16. The method any of Aspects 9 to 15, wherein the attention layer is a window attention layer used to process each subset of pixels individually and wherein features determined using the attention layer correspond to the plurality of windows associated with the subsets of pixels.

Aspect 17. A non-transitory computer-readable medium having stored thereon instructions that, when executed by at least one processor, cause the at least one processor to perform one or more of operations according to any of Aspects 9 to 16.

Aspect 18. An apparatus for image processing comprising one or more means for performing operations according to any of Aspects 9 to 16.

What is claimed is:

1. An apparatus for image processing, the apparatus comprising:
at least one memory; and
at least one processor coupled to the at least one memory and configured to:
process, using a sparse sampling pattern, an image feature map to sample subsets of pixels of a set of pixels associated with the image feature map;
sort the subsets of pixels into a plurality of windows of the image feature map, wherein each subset of pixels from the subsets of pixels is sorted into a respective window from the plurality of windows, and wherein one or more pixels from each subset of pixels are adjusted from a first position to a second position within the image feature map based on the sorting;
process, using an attention layer of a machine learning model, the subsets of pixels sorted into the plurality of windows to determine a first plurality of features of the image feature map; and
adjust the one or more pixels from each subset of pixels to position the one or more pixels from the second position to the first position within the image feature map.

2. The apparatus of claim 1, wherein the plurality of windows are equally shaped and equally sized.

3. The apparatus of claim 1, wherein the sparse sampling pattern samples non-adjacent pixels into the subsets of pixels.

4. The apparatus of claim 1, wherein the sparse sampling pattern includes at least one of a pixel-to-depth sampling, a depth-to-pixel sampling, or dilated convolutions.

5. The apparatus of claim 4, wherein the at least one processor is configured to:
process, using a convolutional layer of the machine learning model, the image feature map to determine a second plurality of features of the image feature map and a reduced resolution representation of the image feature map.

6. The apparatus of claim 5, wherein the reduced resolution representation of the image feature map includes padding and is of a same size and shape as the image feature map.

7. The apparatus of claim 5, wherein the at least one processor is configured to:
determine one or more objects represented in an image associated with the image feature map based on the first plurality of features and the second plurality of features.

8. The apparatus of claim 1, wherein the attention layer is a window attention layer used to process each subset of pixels individually, and wherein features determined using the attention layer correspond to the plurality of windows associated with the subsets of pixels.

9. A method comprising:
processing, using a sparse sampling pattern, an image feature map to sample subsets of pixels of a set of pixels associated with the image feature map;
sorting the subsets of pixels into a plurality of windows of the image feature map, wherein each subset of pixels from the subsets of pixels is sorted into a respective window from the plurality of windows, and wherein one or more pixels from each subset of pixels are adjusted from a first position to a second position within the image feature map based on the sorting;
processing, using an attention layer of a machine learning model, the subsets of pixels sorted into the plurality of windows to determine a first plurality of features of the image feature map; and
adjusting the one or more pixels from each subset of pixels to position the one or more pixels from the second position to the first position within the image feature map.

10. The method of claim 9, wherein the plurality of windows are equally shaped and equally sized.

11. The method of claim 9, wherein the sparse sampling pattern samples non-adjacent pixels into the subsets of pixels.

12. The method of claim 9, wherein the sparse sampling pattern includes at least one of a pixel-to-depth sampling, a depth-to-pixel sampling, or dilated convolutions.

13. The method of claim 12, further comprising:
processing, using a convolutional layer of the machine learning model, the image feature map to determine a second plurality of features of the image feature map and a reduced resolution representation of the image feature map.

14. The method of claim 13, wherein the reduced resolution representation of the image feature map includes padding and is of a same size and shape as the image feature map.

15. The method of claim 13, further comprising:
determining one or more objects represented in an image associated with the image feature map based on the first plurality of features and the second plurality of features.

16. The method of claim 9, wherein the attention layer is a window attention layer used to process each subset of pixels individually, and wherein features determined using the attention layer correspond to the plurality of windows associated with the subsets of pixels.

17. A non-transitory computer-readable medium having stored thereon instructions that, when executed by at least one processor, cause the at least one processor to:
process, using a sparse sampling pattern, an image feature map to sample subsets of pixels of a set of pixels associated with the image feature map;
sort the subsets of pixels into a plurality of windows of the image feature map, wherein each subset of pixels from the subsets of pixels is sorted into a respective window from the plurality of windows, and wherein one or more pixels from each subset of pixels are adjusted from a first position to a second position within the image feature map based on the sorting;
process, using an attention layer of a machine learning model, the subsets of pixels sorted into the plurality of windows to determine a first plurality of features of the image feature map; and
adjust the one or more pixels from each subset of pixels to position the one or more pixels from the second position to the first position within the image feature map.

18. The non-transitory computer-readable medium of claim 17, wherein the plurality of windows are equally shaped and equally sized.

19. The non-transitory computer-readable medium of claim 17, wherein the sparse sampling pattern samples non-adjacent pixels into the subsets of pixels.

20. The non-transitory computer-readable medium of claim 17, wherein the sparse sampling pattern includes at least one of a pixel-to-depth sampling, a depth-to-pixel sampling, or dilated convolutions.
